(19) United States
(12) Patent Application Publication
(10) Pub. No.: US 2015/0007441 A1
(43) Pub. Date: Jan. 8, 2015

(54) DRYING CONTAINER WITH HUMIDITY DISPLAY FUNCTION

(71) Applicant: OK BIOTECH CO. LTD., Hsinchu City (TW)

(72) Inventors: AN-YUAN LEE, Hsinchu City (TW); CHIA-TE LAI, Hsinchu City (TW)

(21) Appl. No.: 13/935,627

(22) Filed: Jul. 5, 2013

(51) Int. Cl. F26B 25/08

(52) U.S. Cl. CPC F26B 25/08
USPC 34/88

(57) ABSTRACT

A drying container with humidity display function is disclosed, which is used for storing biological test pieces and is formed with at least one peeping window to be used for observing a humidity display unit embedded inside the drying container so as to determine whether the biological test pieces inside the drying container had already been exposed to moisture and become damp according to the reading on the humidity display unit.

### FIELD OF THE INVENTION

The present invention relates to a drying container with humidity display function, and more particularly, to a drying containing for storing biological test pieces that is configured with a peeping window.

### BACKGROUND OF THE INVENTION

It is a common problem that the biological test piece is exposed to moisture and become damp, and consequently, the damped biological test piece which is used for placing a biological sample and carrying out detection and signal reading by a detection host machine can not perform normally for enabling the detection host machine to acquire an accurate test result from the biological sample. Therefore, it is common to store the biological test pieces that are available on the market in a drying container for help the biological test pieces to stay dry. Generally, the drying container can be an airtight structure that can be vacuumed, or is simply a can having a drying agent disposed therein, whichever can help the biological test pieces to stay dry.

Generally, drying containers are made of opaque plastic materials, and thus, operationally, it is unable to know before opening the drying container whether or not the biological test pieces stored therein had been exposed to moisture and become damp. Consequently, a user can perform a bio test using a biological test piece without knowing whether the biological test piece is preserved in good quality or not, and thus the user has no way to guarantee that the test result from the detection host machine is accurate. Therefore, any diagnosis based upon the test result may be erroneous. Moreover, for a consumer who is shopping for a container of biological test pieces, it would be very helpful if there is a way for allowing he/she to know the preservation condition of the biological test pieces in every container on the shelf, so that the user can easily select the one container with best quality. On the other hand, by the same way, the shop owner also can easily inspect every container of biological test pieces on the shelf at any time, and thus is able to take those containers containing problematic biological test pieces off shelf just in time for goodwill.

### SUMMARY OF THE INVENTION

In view of the disadvantages of prior art, the primary object of the present invention is to provide a drying container with humidity display function, which is used for storing biological test pieces and is formed with at least one peeping window to be used for observing a humidity display unit embedded inside the drying container so as to determine whether the biological test pieces inside the drying container had already been exposed to moisture and become damp according to the reading on the humidity display unit.

Another object of the invention is to provide a drying container having a humidity sensor disposed therein, in that the humidity sensor is enabled to wirelessly transmit a detection signal through a wireless transmitting unit to a wireless receiving unit that is arranged in a remote server, while allowing the detection signal to be displayed or broadcasted using a display unit or an audio unit embedded in the remote server.

To achieve the above objects, the present invention provides a drying container, adapted for storing biological test pieces, comprising: a cylinder, composed of a sidewall and a bottom; a cap, for covering the cylinder; a humidity display unit, provided to be disposed inside the cylinder; and at least one peeping window, each being disposed on the cap, the sidewall or the bottom at a position wherever for allowing a user to observe the humidity display unit at any viewing angle so as to determine whether the biological test pieces inside the drying container had been exposed to moisture and become damp according to the observation of the humidity display unit.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a drying container of the present invention.

FIG. 2A is a schematic diagram showing a peeping window to be embedded on the cap of a drying container of the present invention.

FIG. 2B is a schematic diagram showing a peeping window to be embedded on the can wall of a drying container of the present invention.

FIG. 2C is a schematic diagram showing a peeping window to be embedded on the can bottom of a drying container of the present invention.

FIG. 3 is a functional block diagram showing how a drying container of the present invention is to communicate with a remote server.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

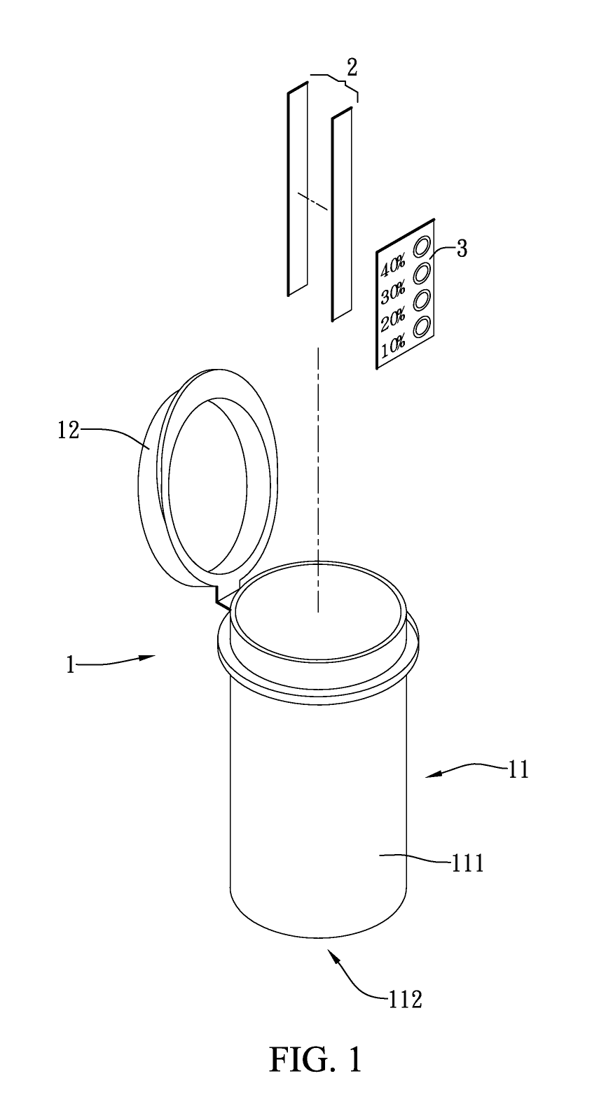

Please refer to FIG. 1, which is a schematic diagram showing a drying container of the present invention. As shown in FIG. 1, the drying container 1, that is adapted for storing biological test pieces, comprises: a cylinder 11, formed with a sidewall 111 and a bottom 112; a cap 12; a humidity display unit 3, disposed inside the cylinder 11; and a drying agent, disposed inside the cylinder 11.

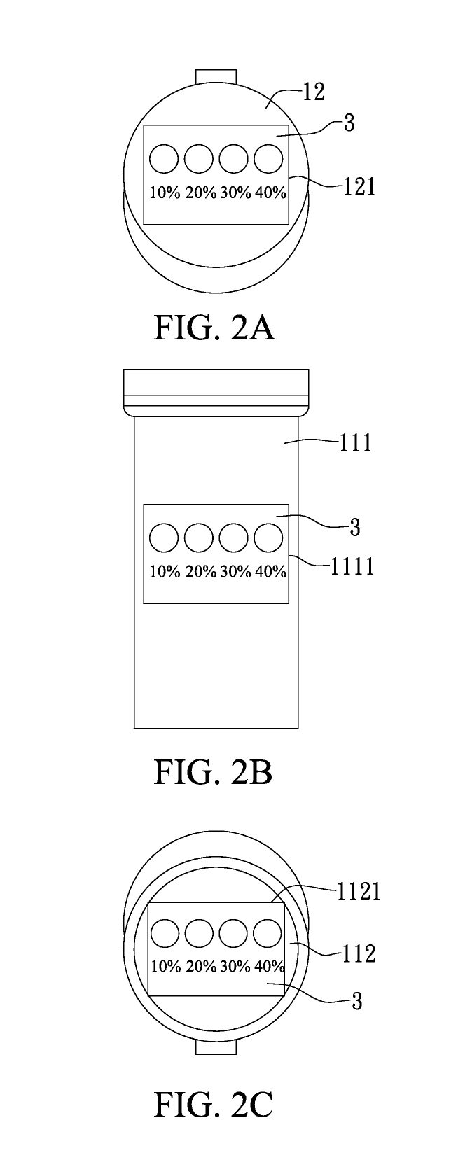

Please refer to FIG. 2A to FIG. 2C, which are schematic diagrams showing respectively three peeping windows that are adapted to be embedded on the cap, the sidewall and the bottom of a drying container of the present invention. In FIG. 2B, there is a first peeping window 1111 installed on the sidewall 111 of the cylinder 11; in FIG. 2C, there is a second peeping window 1121 installed on the bottom 112 of the cylinder 11; and in FIG. 2A, there is a third peeping window 121 installed on the cap 12. In addition, the humidity display unit 3 can be adapted to be attached to any of those peeping windows 1111, 1121 and 121 at a position inside the drying container 1, wherever for allowing a user to observe the humidity display unit 3 at any viewing angle so as to determine whether the biological test pieces inside the drying container 1 had been exposed to moisture and become damp according to the observation of the humidity display unit 3. It is noted that there can be one or more than one peeping windows being installed on the cap 12, the sidewall 111 or the bottom 112 of the drying container 1 of the present invention. Moreover, the humidity display unit 3 can be a humidity indicator card, an electric humidity meter or a mechanical humidity meter. In this embodiment, the humidity display unit 3 is substantially a humidity indicator card, but is not limited thereby.

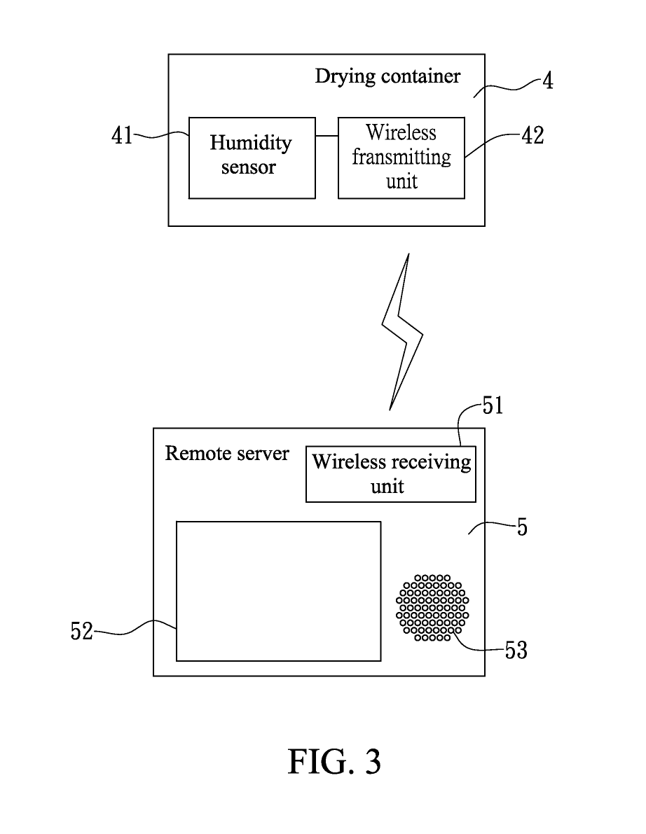

Please refer to FIG. 3, which is a functional block diagram showing how a drying container of the present invention is to communicate with a remote server. As shown in FIG. 3, the drying container 4 is further configured with a humidity sensor 41, in that the humidity sensor 41 is designed to transmit wirelessly a detection value to a wireless receiving unit 51 through a wireless transmitting unit 42. Moreover, as the wireless receiving unit 51 is arranged in a remote server 5, the detection signal is further being transmitted to a display unit 52 or an audio unit 53 that are embedded in the remote server 5, so as to be displayed or broadcasted. In this embodiment, the display unit 52 can be a liquid crystal display, and the audio unit 53 can be a speaker. Thereby, the video displaying of the detection value by the display unit 52 and the audio broadcasting of the detection value by the audio unit 53 can be enabled simultaneously or respectively. Furthermore, the remote server 5 can be a device selected from the group consisting of: a personal computer, a notebook computer, a tablet computer, a personal digital assistant and a smart phone.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A drying container, adapted for storing biological test pieces, comprising:
a cylinder, composed of a sidewall and a bottom;
a cap, for covering the cylinder;
a humidity display unit, provided to be disposed inside the cylinder; and
at least one peeping window, each being disposed on the cap, the sidewall or the bottom at a position wherever for allowing a user to observe the humidity display unit at any viewing angle so as to determine whether the biological test pieces inside the drying container had been exposed to moisture and become damp according to the observation of the humidity display unit.

2. The drying container of claim 1, wherein the humidity display unit is substantially a humidity indicator card.

3. The drying container of claim 1, wherein the humidity display unit is a device selected from the group consisting of: an electric humidity meter and a mechanical humidity meter.

4. The drying container of claim 1, wherein the cylinder further has a drying agent disposed therein.

5. The drying container of claim 1, wherein the cylinder further has a humidity sensor disposed therein and the humidity sensor is designed to transmit wirelessly a detection value to a wireless receiving unit through a wireless transmitting unit.

6. The drying container of claim 5, wherein wireless receiving unit is mounted on a remote server and is capable of displaying or broadcasting the detection value by the use of a display unit or audio unit.

7. The drying container of claim 6, wherein the remote server is a device selected from the group consisting of: a personal computer, a notebook computer, a tablet computer, a personal digital assistant and a smart phone.

8. The drying container of claim 6, wherein the display is substantially a liquid crystal display (LCD).

9. The drying container of claim 6, wherein the audio unit is substantially a speaker.

10. The drying container of claim 1, wherein the humidity sensor is attached to the peeping window at a position inside the drying container.
